(19) United States
(12) Patent Application Publication
(10) Pub. No.: US 2013/0052343 A1
(43) Pub. Date: Feb. 28, 2013

(54) METHOD FOR MANUFACTURING PARTICLES SUCH AS MAGNETIC MICRO- OR NANOPARTICLES

(71) Applicants: Bernard Dieny, Lans en Vercors (FR); Philippe Sabon, Moirans (FR); Jérôme Faure Vincent, Grenoble (FR)

(72) Inventors: Bernard Dieny, Lans en Vercors (FR); Philippe Sabon, Moirans (FR); Jérôme Faure Vincent, Grenoble (FR)

(73) Assignee: Commissariat à l' énergie atomique et aux énergies alternatives, Paris (FR)

(21) Appl. No.: 13/640,666

(22) PCT Filed: Apr. 12, 2011
(86) PCT No.: PCT/FR11/50842

§ 371 Date: Nov. 14, 2012

(30) Foreign Application Priority Data
Apr. 12, 2010 (FR) 1052743

(51) Int. Cl. H01F 41/00; B05D 7/00; B29C 41/00

(52) U.S. Cl. 427/212; 264/219; 164/6

(57) ABSTRACT

A method for manufacturing particles includes depositing on a substrate a layer of a first sacrificial material; depositing on the layer of the first sacrificial material a layer of a second sacrificial material that is different from the first sacrificial material; forming cavities in the layer of the second sacrificial material, the forming including pressing a structured mold against the layer of second sacrificial material; depositing a material for manufacturing the particles, the material covering the layer of the second material and at least partially filling the cavities; selectively removing the second sacrificial material from the first sacrificial material so as to obtain the particles formed by the material and arranged on the layer of the first sacrificial material; and eliminating the first sacrificial material to release the particles.

The present invention relates to a method for manufacturing particles such as magnetic micro- or nanoparticles.

In a known manner, magnetic micro- or nanoparticles are increasingly used in biotechnology or biomedical applications. Interest in these types of particles resides in the possibility to remotely exert a force on these particles by applying a magnetic field. Solution is understood to refer to any liquid such as water, blood, glycerin, a solvent; It may also be a biological medium such as spinal marrow.

This magnetic force may enable the microparticles to be guided during their displacement, to concentrate them in certain locations, to deform them or magnetically excite them so that they dissipate energy and become heated.

By utilizing magnetic particles alone or by grafting different types of molecules onto their surface, enabling recognition of certain molecular or cellular species and/or an action on these species, numerous applications are possible. Among these applications may be cited the targeted delivery of treatment molecules (drug delivery), the separation of molecules or cells in suspension (called MACS or Magnetic Cell Sorting), cancer treatments by hyperthermia, cell tissue engineering or use as contrast media in MRI (Magnetic Resonance Imaging).

The particles currently used are most often iron oxide particles (magnetite Fe₃O₄ or maghemite γ-Fe₂O₃), or cobalt or iron covered by an inorganic envelope for example of silica or gold, making them biocompatible. Depending on the targeted applications, these particles may have dimensions of several microns (typically a “drug delivery” type application) or some nanometers (use as an MRI contrast agent). These particles are generally in an approximately spherical form and are obtained by a chemical manufacturing method (“bottom-up”) leading to the formation of colloidal solutions.

A defect of such ferromagnetic particles (having a remanent magnetic moment in null field) is their tendency to agglomerate to each other by magnetostatic interactions. In order to avoid this agglomeration phenomenon, particles or particle clusters are enclosed in envelopes (for example Dextran envelopes). They have a null magnetic moment in null field but present a strong magnetic susceptibility; i.e., they acquire a magnetic moment when they are exposed to a magnetic field. In addition, the particles or particle clusters may be surrounded by a matrix of ligands, preventing them from getting too close to each other.

This particle type presents a major disadvantage connected to their iron oxide-based material and to their approximately spherical form.

Therefore, due to the fact that these magnetic particles used are almost always constituted of the same materials (iron oxide), the properties of these particles are obviously not optimized for the very diverse applications cited above.

For example, for applications requiring the displacement of magnetic particles in a fluid (“drug delivery,” molecular separation in solution, etc.), the magnetic force must be sufficiently high to overcome the hydro- or hemodynamic forces. If the particles are spherical, the hydro- or hemodynamic resistance forces are proportional to the square of the radius of the particle (scattering cross section) and the magnetic forces are proportional to the volume, i.e., to the cube of the radius. With magnetite particles, to obtain sufficient magnetic forces to guide particles circulating in the blood flow requires particles of micrometric size (i.e., diameter greater than 2 or 3 μm): These particles, by virtue of their size, cannot necessarily circulate in all blood vessels. In addition, iron oxides obtain relatively reduced magnetic moments per volume unit and consequently obtain magnetic forces that are also reduced.

One known alternative to the method for manufacturing approximately spherical microparticles by chemical route leading to the formation of colloidal solutions consists of using a collective planarization method using a structured resin to define the particles. This method is particularly described in the document “High moment antiferromagnetic nano-particles with tunable magnetic properties” (Wei Hu et al., Stanford Univ., CA, USA, Adv. Mater., 2008, 1479-1483). The first step of this method consists of making a contact array in resin. This array of contacts may, for example, be obtained by optical or electronic lithography.

It may also be made by nanoimprinting by using a mold of pre-etched silicon contacts (the nanoimprinting technique consists of making a mold that contains the imprint of whatever one wishes to make; One then places a layer of polymer resin on the smooth substrate, presses the mold against the resin so that the form of the contacts is transferred into the resin and then removes the mold). The top surface of each contact should represent the shape of the magnetic particle to be manufactured. Once the contacts are manufactured, at least one layer of magnetic material is deposited on the tops of each of the contacts. Then, the particles are released (“lift-off”) by eliminating the resin serving as the sacrificial material. A solvent is used for this purpose, the particles integral with the contacts are detached and are free to move in the solvent utilized.

However, this planarization method presents certain difficulties, particularly when the contact array is obtained lithographically.

In fact, resin exposure may lead to swelling of the resin and to surface granularity; as the form of the particles follows the form of the contacts, it is very difficult to make the manufactured objects planar. In addition, the etched resin pattern sides obtained by lithography often form an angle that is not exactly perpendicular with relation to the substrate surface; Consequently, deposition conformity of the magnetic material means that the latter is deposited not only on the top of the contacts but also on the sides, leading to an undesired form being obtained.

This planarization method is also likely to present certain difficulties when the contact array is obtained by nanoimprinting.

In fact, after pressing the mold against the resin, the base of the patterns is released by using a plasma treatment in order to remove the resin pressed under the mold. This plasma may alter the top of the resin contacts. In addition, it is not unusual that the molds used for nanoimprinting present mold base defects; The latter will de facto lead to defects at the tops of resin contacts whose form is directly linked to that of the mold base.

In this context, the object of the present invention is to provide a method for manufacturing magnetic particles offering a high degree of flexibility regarding the form and composition of the particles obtained with very low scattering of properties from one particle to another, said method also obtaining particles whose size and planarity are very well controlled.

For this purpose, the invention proposes a method for manufacturing particles characterized in that the method comprises the following steps:
deposition on a substrate of a layer of a first sacrificial material;
deposition of a layer of a second sacrificial material that is different from said first sacrificial material;
structuring the layer of the second sacrificial material by forming holes in the shape of the magnetic particles to be manufactured, said structuring of the layer of second sacrificial material being done by using a structured mold,
   by pressing said mold against said layer of second sacrificial material;
deposition of at least one material for manufacturing said particles, said manufacturing material covering the layer of the second material and at least partially filling said holes;
selectively removing said second sacrificial material from said first sacrificial material so as to obtain the particles formed by said manufacturing material filling the holes and arranged on said layer of said first sacrificial material;
Elimination of said first sacrificial material such that said particles are released.

Particle is understood to refer to micro- or nanometric particles, i.e., particles whose dimensions are less than 500 μm and preferably less than 100 μm. These particles preferably are magnetic particles.

Thanks to the invention, the particles are prepared by depositing at least one layer of manufacturing material, for example a layer of a magnetic material (and generally a magnetic multilayer) of a composition chosen according to the targeted application, on a particular substrate. This substrate is covered by two layers of different materials (for example, a first and second polymer). The second material is prestructured with holes with the form of particles/objects to be manufactured. Deposition of the material for manufacturing particles (obtained for example by cathode sputtering) then covers the top of the second material and the base of the holes.

Then, the second material is eliminated (for example by dipping the substrate and depositing it in an appropriate solvent solution) that has the effect of releasing the deposition of manufacturing material at the top of the layer of second material (lift-off method) without removing that from the hole base; The manufacturing material deposited at the base of the holes constitutes the particles/objects of interest. Therefore objects are structured on the first material. At this stage, it is possible to graft on the upper face of the particles thus manufactured molecules or another object of interest for the targeted biotechnology application (it will be noted that this operation may also be carried out before removal of the second material).

The first material is then eliminated (for example in a solvent solution suitable for dissolving the first material) and the particles/objects thus created are released in the solution. Therefore it is understood that the particles manufactured should not have a spherical form but a form directly linked to the form of the hole and will have a planarity directly linked to that of the layer of first material (layer in which the planarity may be on the order of some nanometers).

Flat type particles may therefore be manufactured by using a very even layer of first material (not having undergone any exposure, contrary to known standard methods) with lateral sides perpendicular to the substrate.

Particles with more complex forms may also be manufactured either by adjusting the form of the holes made in the second material or the angles of incidence along which magnetic material depositions are performed relative to the normal to the substrate plane.

The method according to the invention may also present one or more of the characteristics below, considered individually or according to all technically possible combinations:
said holes are arranged so as to form an array of holes distributed on said layer of second sacrificial material;
said mold comprises protuberances, the three-dimensional form of which determines the form of said holes;
the glass transition temperature of said second sacrificial material is strictly less than the glass transition temperature of said first sacrificial material;
said selective removal is carried out by dissolving said second sacrificial material in an appropriate solvent, said solvent dissolving only said second sacrificial material without affecting said first sacrificial material, said part of the manufacturing material present in said holes remaining attached to said layer of first sacrificial material;
said elimination of said first sacrificial material is carried out by dissolving said first sacrificial material;
said first material is a methyl methacrylate type polymer such as PMMA;
said first material is a material chosen from among the following materials:
   amorphous or semicrystalline polymer;
   oligomer;
   monomer;
   metal;
   oxide;
   ceramic;
   biological material such as cells or DNA strands;
said second material is a material chosen from among the following materials:
   amorphous or semicrystalline polymer;
   oligomer;
   monomer;
   metal;
   oxide;
   biological material;
said manufacturing material is a magnetic material such that magnetic particles are obtained;
said deposition of at least one magnetic material comprises a step of depositing a multilayer formed by a plurality of magnetic layers with antiparallel magnetizations separated by a non-magnetic layer made in a material able to induce antiferromagnetic coupling between the magnetic layers that it separates;
said magnetic multilayer is an iron/chromium multilayer of general form (Fe/Cr)m or a nickel-iron-cobalt/ruthenium alloy multilayer of general form (Ni_{1-x-y}FeₓCo_{y}/Ru)n, x and y being real numbers between 0 and 1 characterizing the relative concentrations of Fe and Co in the alloy, m and n designate natural integers respectively corresponding to the numbers of respective repetitions of Fe/Cr and Ni_{1-x-y}FeₓCo_{y}/Ru patterns;
said at least one magnetic material is chosen so that it presents a substantially squared hysteresis loop;
said deposition of at least one manufacturing material is preceded by a step of depositing a first layer of biocompatible material and is followed by a step of depositing a second layer of biocompatible material so that said biocompatible material is on both sides of said manufacturing material;
the method according to the invention comprises a chemical treatment step of the sides of said particles to deposit a biocompatible material on said sides;
the method according to the invention comprises a step of grafting elements of interest on said particles.

Other characteristics and advantages of the invention will clearly emerge from the description given below, for indicative and in no way limiting purposes, with reference to the attached figures, among which:

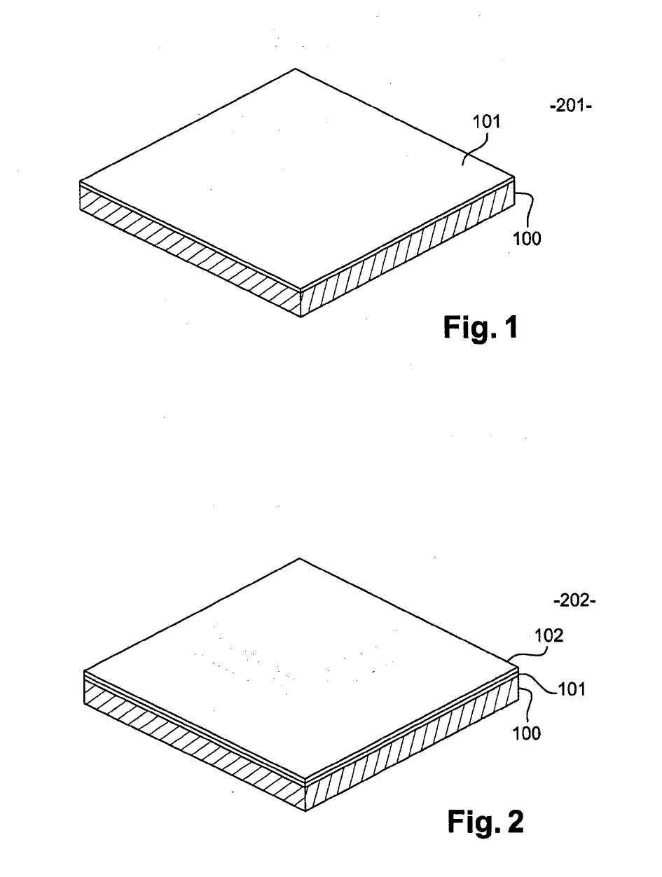

FIGS. 1 to 7 illustrate the various steps of a first embodiment of the method according to the invention;

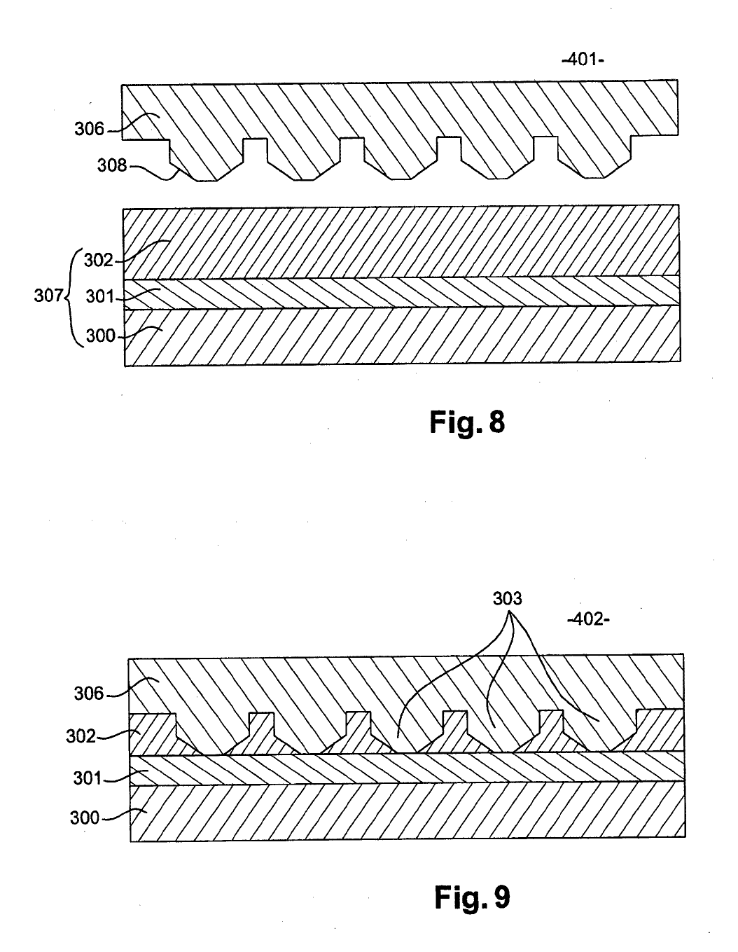

FIGS. 8 to 11 illustrate the various steps of a second embodiment of the method according to the invention;

In all figures, common elements bear the same reference numbers.

FIGS. 1 to 7 illustrate the various steps of a first embodiment according to the invention.

According to a first step 201 (FIG. 1), a layer 101 of a first polymer is laid on a substrate 100 (for example in silicon).

Layer 101 of first polymer is for example obtained by a spin coating method. The principle consists of laying, by using centrifugal forces, a small quantity of polymeric resin on the substrate, for example by using a spinner that suctions the wafer so that it is not ejected during rotation. Deposition of this polymer may also be done by resin evaporation or spray coating. The thickness of this layer 101 of first polymer may be a few tens of nanometers to several microns, its surface roughness and planarity are directly linked to the planarity of the final object (micro- or nanoparticles that are to be obtained).

According to a second step 202 (FIG. 2), a layer 102 of a second polymer is deposited (according to a technique that may be identical to that of the layer 101 deposition) on the layer 101 of a first polymer. According to this first embodiment, the second polymer is chosen to be photosensitive and/or electrosensitive. This layer 102 will subsequently be used as a mold for the objects/particles that will be obtained.

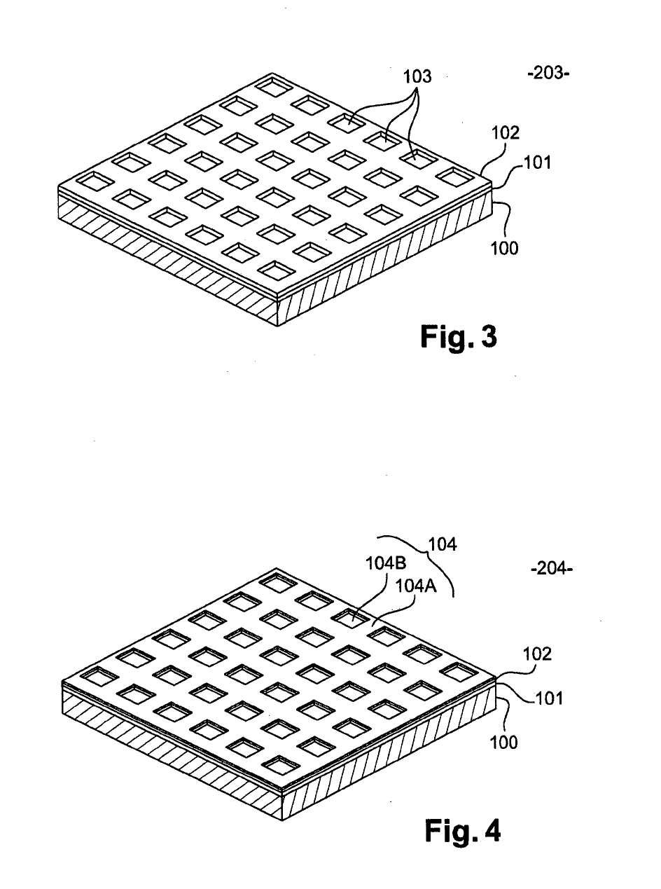

According to a third step 203 (FIG. 3), holes 103 are made in layer 102 of the second polymer, said holes 103 have the form of the magnetic particles that are to be manufactured: Here the holes 103 have a substantially perpendicular form with a flat base surface (planarity dictated by layer 101 of the first polymer) and lateral sides perpendicular to the base surface. Holes 103 are defined in layer 102 of the second polymer for example by lithography (optical or electronic) or by pressing a mold and layer 102; this lithography step proceeds by exposure (for example by UV radiation) of a fraction of the polymeric resin layer 102 through a mask comprising a UV radiation transparent part and a UV radiation opaque part defining the patterns of holes to be made; A latent image in the thickness of the photosensitive polymer resin is then created by photochemical reaction. The patterns are then developed in a developer specific to the second polymer; the latter preferentially attacks either the fraction of resin polymerized by exposure (positive resin) or the fraction of unexposed resin (negative resin); After development, holes 103 in the form of the mask are thus created.

For example, PMMA (polymethyl methacrylate) with a 2% dilution is used for the first polymer. It is understood that 2% PMMA is mentioned here for purely illustrative purposes regarding the first material forming layer 101: it is thus possible to use other PMMA dilutions for the first polymer and other types of polymers (from the same family as PMMA or not) or even a non-polymer film of the metal, oxide, ceramic or biological type; The only condition being that the second material used for layer 102 can be eliminated selectively with relation to the first material of layer 101. PMMA is polymethyl methacrylate, the molecular weight of which varies between 50000 (fifty thousand) and 2.2 million. In general, the higher the molecular weight, the slower the dissolution in a solvent. For the first material, all polymers of the methyl methacrylate type may be used.

The photosensitive resin (second polymer) may be a positive resin, for example a phenolic novolac type polymer (phenolformaldehyde resin) doped with a photoactive agent (diazonaphthoquinone or DNQ). DNQ inhibits the dissolution of the novolac resin; however, under exposure to light, the level of dissolution increases even beyond that of pure novolac. The second polymer is therefore for example an MaN-2403 type resin. DUV “Deep Ultra-Violet” photosensitive resins may also be used for the second polymer, which typically are polymers based on polyhydroxystyrenes with a photoacid generator procuring the change in solubility after exposure.

An amplified negative photosensitive resin based on epoxy type polymers and the release of Lewis acid by the photoinitiator may also be used.

In general, the photosensitive resin (second polymer) may be positive or negative photosensitive or electrosensitive. The second polymer may also not be photosensitive or electrosensitive, its structuring may be carried out by nano- or microimprinting (we will return to this embodiment in reference to FIGS. 9 to 12).

It will be noted that the holes 103 in layer 102 of the second polymer may also be made by electronic lithography; However, if the second polymer is only photosensitive and not electrosensitive, a layer of a third electrosensitive polymer resin (not represented) deposited on layer 102 of the second polymer should be used in this case. This upper layer of a third electrosensitive polymer resin will then be structured by electronic lithography by defining an array of holes on this layer. These holes are made up to the upper surface of layer 102 of the second polymer. Oxygen plasma etching of layer 102 of the second polymer accessible through the holes defined in the layer of the third polymer resin is then carried out; this etching is carried out up to the upper surface of layer 101 of the first polymer; In this way, the pattern defined by the electronic lithography made on the upper layer (not represented) is transferred to layer 102 of the second polymer so as to obtain the array of holes 103 of layer 102.

A resin of the UV5™ type produced by the Rohm&Haas company, for example, may be used for the third electrosensitive resin.

Fourth step 204, illustrated in FIG. 4, consists of depositing a magnetic film 104 that will constitute the particle or object. This magnetic film comprises at least one magnetic layer and generally is a multilayer assembly formed by magnetic and non-magnetic layers; We will return to the composition of this film 104 in what follows (to simplify the representation, the multilayer film will be systematically represented subsequently by a single layer). Film 104 is also deposited on both the upper surface of layer 102 of the second polymer (part 104A of film 104), and in holes 103 (or meanders) of layer 102 (part 104B of film 104).

If the application requires biological compatibility, the invention starts (before deposition of the magnetic multilayer 104) by depositing a sublayer of biocompatible material (not represented) for example in gold (Au) or silica.

The multilayer magnetic film 104 may for example comprise at least two magnetic layers separated by a non-magnetic intermediate layer (metallic or insulating) enabling non parallel coupling to be exerted between the two adjacent magnetic layers. Typically, multilayer 104 may be a stack (NiFeCo 20 nm/Ru 0.7 nm)ₙ, where n is the number of repetitions of the bilayer NiFeCo/Ru pattern, formed by alternating magnetic layers of Ni, Fe and Co based alloys with a thickness of 20 nm antiferromagnetically coupled through non-magnetic separation layers, for example of Ru with a thickness of 0.7 nm. Multilayer 104 may also be a stack of the (Fe 20 nm/Cr 1 nm)ₙ type.

All of these layers may be deposited for example by atomic vapor deposition techniques and particularly by cathode sputtering, but also by ALD “Atomic Layer Deposition.” The multilayers (alternating magnetic and non-magnetic layers) presenting antiferromagnetic coupling between successive layers through the non-magnetic layers are of particular interest. In fact, to avoid the problem of magnetic particle aggregation, superparamagnetic particles that present a null magnetization in null field must be used. But for a magnetic particle to be superparamagnetic, its size must be very small, typically less than 25 nm for iron oxide particles as used in the prior art (see for example the article “Magnetic particles for drug delivery”—M. Arruedo et al, Nanotoday, 2 (2007) 22). Such being the case, the magnetic force on such a small particle is insufficient to overcome the hemodynamic force linked to blood flow. The particles obtained by the method according to the invention constituted of a multilayer magnetic metal/non-magnetic metal structure presenting antiferromagnetic coupling between successive magnetic layers present properties that are very similar to the superparamagnetic particles; i.e., null magnetization at null field but high magnetic field polarizability and even saturation magnetization that may be much higher (factor 3 to 4) than for “conventional” iron oxide based particles. These properties are present in these nanoparticles regardless of their size. Therefore, the particles obtained by the method according to the invention depart from this basic superparamagnetic character constraint imposed on nanoparticles from the prior art.

After deposition of the magnetic multilayer 104, if the application requires biological compatibility, the deposition is finished with a layer (not represented) of biocompatible material (gold or silica for example) that covers the entire upper part of the nanostructure.

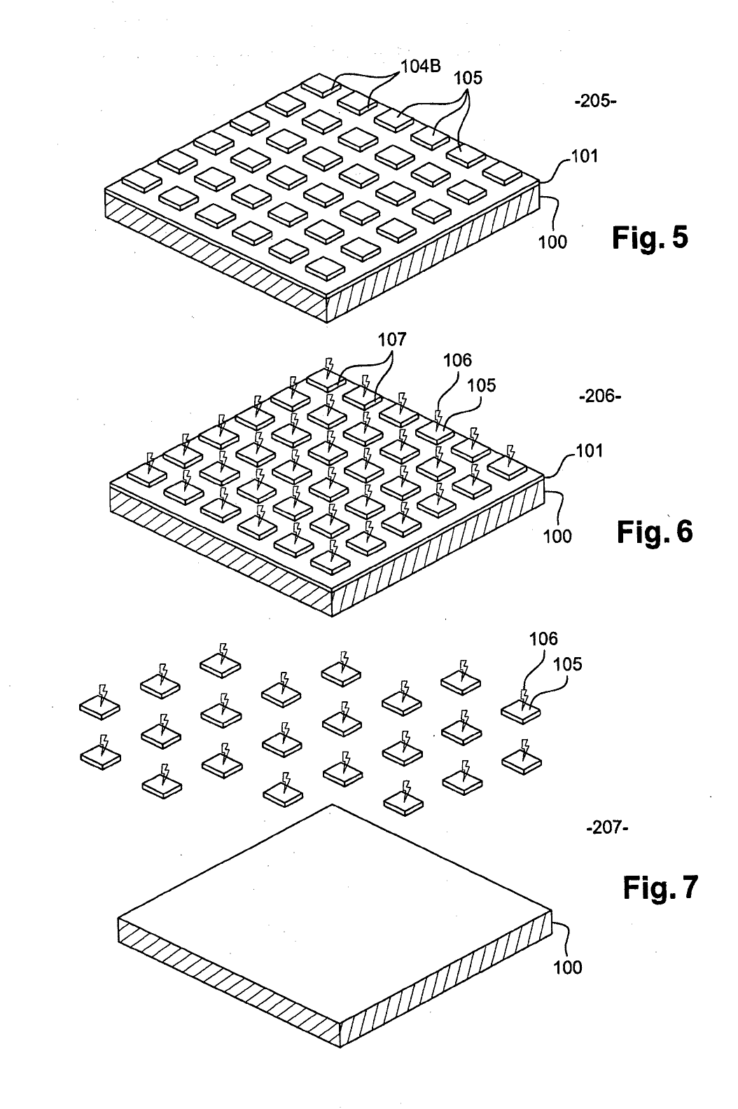

The fifth step 205, illustrated in FIG. 5, consists of selectively eliminating structured layer 102 of the second polymer with relation to layer 101 of the first polymer, said layer 102 may be dissolved without altering layer 101. To do this, the structure assembly as represented in FIG. 5 is plunged into an appropriate solvent solution. This solvent must only dissolve layer 102 without affecting layer 101; In the case of resin MaN-2403 used for layer 102, isopropyl alcohol may be used as the solvent.

By releasing layer 102 of the second polymer, magnetic deposition 104A present on layer 102 is also eliminated while magnetic deposition 104B is maintained in holes 103. This magnetic deposition 104B thereby forms particles 105 clinging to layer 101 of the first polymer and structured by the form of the holes 103. Thus it is understood that the manufactured particles 105 will not have a spherical form but a flat form, the planarity of which is directly linked to that of layer 101 of the first polymer. In other words, the form of particles 105 is completely determined by the form of holes 103 and the planarity of layer 101 of the first polymer. After this release, layer 101 of the first material and the structured objects 105 are therefore maintained on substrate 100.

According to step 206 (FIG. 6), if the application requires biological compatibility, sides 107 of particles 105 are covered. To do this, a chemical treatment may be used to carry out a biocompatible deposition of gold (via liquid phase chemical deposition for example) or a physical vapor deposition or PVD, for example by cathode sputtering in oblique projection. A deposition of silica (via gaseous phase or liquid phase silylation for example) may also be carried out.

According to this same step 206, particular elements of interest 106 may be grafted to particles 105 (on their face opposite from the face in contact with layer 101 of the first polymer material) for a targeted biotechnological application. It will be noted that this grafting may also intervene after deposition of the magnetic multilayer 104. Among the objects 106 likely to be grafted to these particles 105 may be cited strands of DNA or RNA, antibodies/antigens, cells, molecules (monomers or oligomers) having, for example, fluorescence or phosphorescence properties, polymer fibers (poly(3-hexylthiophene type)), radioactive tracers, etc. The grafting of other objects of a different form and/or nature may also be considered, for example objects for biological recognition (antibodies/antigens), carbon nanotubes, silicon or other semiconductors.

It will be noted that the grafting of objects of interest may also be carried out before removal of layer 102 of the second polymer material (typically after deposition of the covering layer in a biocompatible material), removal of layer 102 of the second polymer not affecting the species grafted onto the magnetic depositions.

According to step 207 (FIG. 7), particles 105 grafted by objects 106 are released via a specific chemical attack enabling layer 101 of the first polymer to be removed; To do this, for example in the case of a first polymer in 2% PMMA resin, the assembly as represented in FIG. 6 is plunged into an acetone solution, the grafted particles 105 are found in solution. Of course, considering the observations made above on the nature of the possible first materials, the film dissolution chemistry and particle release depend on the choice of these materials and may be acids, bases, solvents or any other organic, mineral or biological chemical solutions.

Particles 105 suspended in the dissolution solution may then be recovered by attracting them with a magnet on the edge of the container in order to stop them, and the liquid may be changed if necessary.

In the description of the first embodiment above, the particles manufactured have a form of mesas constituted of flat base faces and lateral sides perpendicular to the bases.

It goes without saying that the form of the objects manufactured entirely depends on the form that is given to the holes 103 by structuring the layer 102 of the second polymer. All form types are possible, the only limit being the resolution of the optical/electronic lithography or nanoimprinting technique used to prepare the substrate.

These forms may for example be square or rectangular, round or oval, star-like, in rings, in grids, in very elongated ribbons.

As mentioned above in the description from the prior art, if the particles are spherical, the hydro- or hemodynamic resistance forces are proportional to the square of the radius of the particle (scattering cross section) and the magnetic forces are proportional to the volume, i.e., to the cube of the radius. Therefore, with known magnetite particles, to obtain sufficient magnetic forces to guide the particles circulating in the blood flow, particles with a diameter greater than 2 or 3 microns are required. The method according to the invention obtains elongated or flattened particles that are displaced perpendicularly to their smallest surface. By using such particles, the ratio of the volume scattering cross section may be changed, thereby enabling the smallest particles to be guided in the blood flow.

These forms may also be out-of-plane in the context of nanoimprinting with molds presenting for example conical, spherical or pyramidal forms as will now be described with reference to the references in FIGS. 8 to 11 that illustrate the various steps of a second embodiment of the method according to the invention.

According to a first step 401 (FIG. 8), this method consists of using a mold 306 and a structure 307 substantially identical to the structure represented in FIG. 2.

This structure 307 is made by placing a layer 301 of a first polymer resin and a layer 302 of a second polymer resin different from the first resin on a substrate 300 (for example in silicon).

Mold 306 typically is a mold in Si comprising protuberances 308 in relief, each protuberance presenting a substantially trapezoidal end. This trapezoidal form is given for purely illustrative purposes and other forms may of course be used (for example conical or partially spherical ends). In a known manner, such molds may be obtained by chemical etching of the RIE (Reactive Ion Etching) type.

In the case of a protuberance of a pyramidal form with a truncated top, the mold may be obtained by chemical etching of a silicon substrate <100>, thus creating pyramids of known slope specific to the crystalline orientation of the substrate and etching planes; In the case of silicon <100>, the slope of the pyramid forms an angle of 54.74 degrees is with the substrate plane. If this etching is stopped during the etching process, a truncated pyramid is obtained. In the case of complete etching, the etching stops on its own and a complete pyramid is obtained.

To make these rounded forms, an SF6 RIE etching method is used, that is very isotropic, thereby creating protuberances with rounded concave edges (sides).

Protuberances in spherical or hemispherical form may be m obtained by using polyester or latex beads or other metal or ceramic beads.

According to step 402 (FIG. 9), the mold 306 and the layer 302 of the second polymer resin will then be pressed.

The imprinting is generally hot imprinting, assisted or not by UV, at a temperature where the resin is relatively fluid.

m Therefore, in a particularly advantageous manner, at the time of the imprinting, the temperature will be increased beyond the glass transition temperature of layer 302 of the second sacrificial material (second polymer resin), the materials of layers 301 and 302 being chosen so that the glass transition temperature of the second sacrificial material (layer 302) is strictly less than the glass transition temperature of the first sacrificial material (layer 301). In the case, for example, of resin TU2 provided by the Obducat™ company (layer 302 material), the glass transition temperature is 65° C. while layer 301 is made of PMMA, the transition temperature of which is between 105° C. and 115° C.; Therefore, layer 301 of the first sacrificial material is not deformed during imprinting. Other types of amorphous, semicrystalline polymers or monomers or oligomers may be used as layers 301 or 302 on the condition that they have different glass transition temperatures.

Layer 302 may also be a metal, oxide, ceramic or a biological material.

Holes 303 are then directly imprinted in layer 302 of resin, the form of which is the same as the form of protuberances 308 of mold 306.

Next, the resin is cooled and it solidifies, and the mold is carefully removed. The mold is generally covered by an anti-adhesive layer, not represented, to facilitate its removal, preventing the patterns formed in the resin from tearing off during removal.

The second polymer resin is chosen so that it is more fluid than the first denser polymer resin so that only layer 302 of the second polymer resin is deformed during pressing. In the case of thermoplastic material (amorphous or semicrystalline polymers), the viscosities are typically between 10⁴ and 10⁸ Pa·s. In the case of monomers or oligomers, the viscosities are between 10 mPa·s and 10000 mPa·s.

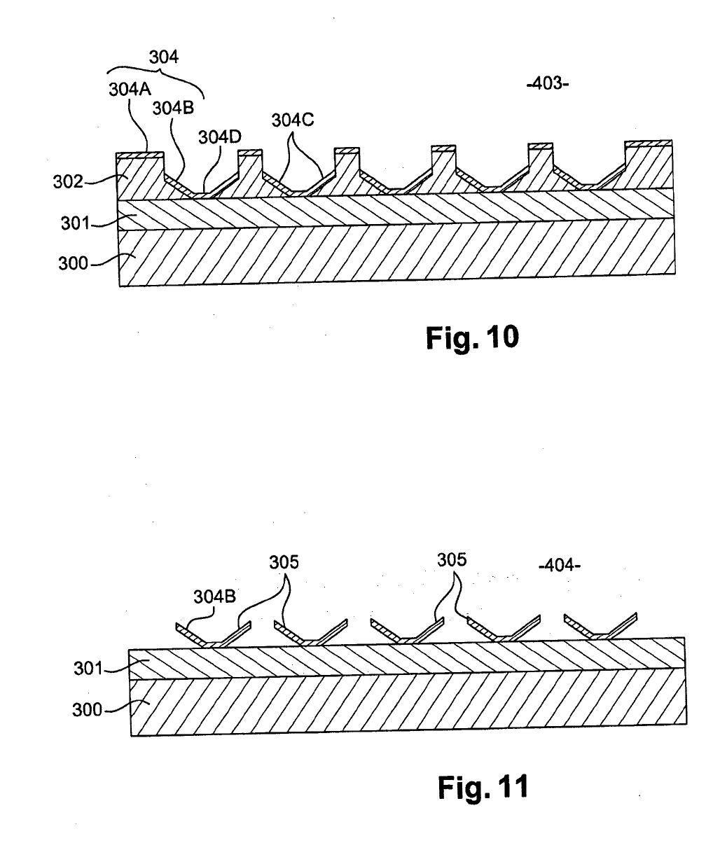

Step 403, illustrated in FIG. 10, consists of carrying out a conformal deposit of a magnetic film 304 that will constitute the particle or object. This magnetic film comprises at least one magnetic layer and generally is a multilayer assembly formed by magnetic and non-magnetic layers; The composition of this film 304 may be identical to the composition of film 104 illustrated during the first embodiment. Film 304 is also deposited on both the upper surface of layer 302 of the second polymer (part 304a of film 304), and in holes 303 of pyramidal form of layer 302 (part 304b of film 304).

If the application requires biological compatibility, the invention starts (before deposition of the magnetic multilayer 304) by depositing a sublayer of biocompatible material (not represented) for example in gold (Au) or silica.

After deposition of the magnetic multilayer 304, if the application requires biological compatibility, the deposition is finished with a layer (not represented) of biocompatible material (gold or silica for example) that covers the entire upper part of the nanostructure.

Step 404, illustrated in FIG. 11, consists of selectively eliminating structured layer 302 of the second polymer with relation to layer 301 of the first polymer, said layer 302 may be dissolved without altering layer 301. To do this, the structure assembly as represented in FIG. 10 is plunged into an appropriate solvent solution. This solvent must only dissolve layer 302 without affecting layer 301.

By releasing layer 302 of the second polymer, the magnetic deposition 304A present on layer 302 is also eliminated while magnetic layer 304B is maintained in holes 303 (edges 304C of magnetic deposition 304B are integral with the bottom 304D of magnetic deposition 304A and are therefore not eliminated with magnetic deposition 304A). This magnetic deposition 304B thus forms particles 305 clinging to layer 301 of the first polymer and structured by the form of holes 303. The interest of this second embodiment is that it enables, via using mold 306, particles 305 in complex 3D form (here the form of a cup) to be obtained.

As for the first embodiment, it is also possible to cover the sides of particles 305 as well as graft elements of particular interest onto particles 305.

Particles 305 may then be released via a specific chemical attack enabling layer 301 of the first polymer to be removed.

Of course, the invention is not limited to the embodiments just described.

Therefore, the term “solvent” is to be understood in a broad sense; it designates a liquid capable of dissolving and/or attacking polymers (thus possibly destroying and not only dissolving them); A solvent may be, for example, an acid, base, alcohol, ketone or aromatic compounds. The term “solvent” therefore is not restricted to the families of protic, polar aprotic, apolar aprotic or ionic solvents but refers to all organic chemical, mineral or biological solutions.

In addition, even if the layer of second material was essentially described in the context of using a polymer, the second material may be of another type: Metallic, oxide, ceramic, biological.

In addition, the structuring of this layer of second material is described via a lithography or nano- or microimprinting technique. However, it is possible to use other techniques for structuring, for example by stamping, by laser etching or by an FIB “Focused Ion Beam” technique.

In addition, even if two ways of obtaining particles of complex form were mainly described (either by adjusting the form of the holes obtained by lithography or by using molds with patterns of a particular form pressed into the second material), it is also possible to adjust the angles of incidence along which depositions of the magnetic multilayer are carried out relative to the normal to the substrate plane.

It will also be noted that the particles already grafted on one of their sides during the method according to the invention may be grafted on their opposite side after they are solutionized (release after dissolution of the second material); To do this, chemical grafting in solution may be used.

In addition, when it comes to the magnetic multilayer used for manufacturing particles, the embodiments described previously relate to alternating magnetic layers antiferromagnetically coupled through non-magnetic separation layers. Other types of magnetic structures are also possible; The method according to the invention in fact uses in a very flexible manner different materials depending on the targeted application, the only condition being that the materials forming the particle at least partially fill the holes made in the layer of the second material. Therefore, one may also make thin magnetic layers or multilayers presenting a very well defined uniaxial anisotropy, i.e., a preferred axis of orientation for magnetization. Such uniaxial anisotropy may be carried out by depositing magnetic materials under magnetic field. For example, layers of Ni₈₀Fe₂₀ Permalloy present such uniaxial anisotropy when they are deposited under field.

Uniaxial anisotropy may also be induced by depositing the magnetic material on a substrate in oblique projection. The magnetic layer then presents uniaxial anisotropy in the plane of the layer, perpendicular to the plane of incidence of the species deposited.

Multilayer stacks may also be made presenting uniaxial anisotropy perpendicular to the plane of the layers and therefore to the plane of the substrate. This is the case, for example, of multilayers (Pt 2 nm/Co 0.6 nm)ₙ, where n is the number of repetitions of the bilayer pattern Pt/Co. In this type of system, out-of-plane anisotropy exists, of crystallographic or interfacial origin (stress, electronic hybridization or break in symmetry effects) that may exceed the shape anisotropy of magnetostatic origin. In thin layers, shape anisotropy tends to maintain the magnetization of magnetic layers in their plane. But in multilayers (Pt/Co), the perpendicular anisotropy of interfacial origin manages to overcome the shape anisotropy so that the magnetizations of Co layers point perpendicularly to the interfaces. These systems therefore present a very well defined uniaxial anisotropy perpendicular to the plane of the layers. The hysteresis loop (magnetization curve of the magnetic material depending on the field applied) of a magnetic layer presenting well defined uniaxial anisotropy is squared when the magnetic field is applied along the easy axis of magnetization. The magnetization reversal field, called the coercive field, may take values from a few tenths of milli-tesla to 1 or 2 tesla in permanent magnet type thin layers. On the contrary, when the field is applied along the hard axis of magnetization, the hysteresis loop is linear and reversible between the positive and negative saturation. For certain biomedical applications, seeking to dissipate energy in the magnetic material (cancer treatment by hyperthermia for example), it is of interest that the hysteresis loop is as open as possible (squared) since the surface of the loop is linked to the energy dissipated throughout the loop when the magnetic layer is subjected to a variable magnetic field. Therefore, using a material whose loop is squared maximizes the energy dissipated per loop.

It is also possible to produce stacks of materials with different magnetoelastic properties. Magnetoelastic materials present anisotropic variations in volume (for example length contraction parallel to the field of some 10−⁴ in relative value). They may expand under field in one dimension and contract in another. In combination in a bilayer structure, two layers with different magnetoelastic properties, internal stresses may be induced in the bilayer under field. If the substrate is sufficiently flexible or if the bilayer is released from its substrate, these internal stresses may lead to deformation of the bilayer controllable by the magnetic field.

Lastly, even if the method according to the invention is particularly suitable for manufacturing magnetic particles, one may also use it to obtain particles manufactured in other manufacturing materials, for example metallic particles (in Au) or semiconducting particles; The manufacturing material of such particles may for example be deposited by known methods of the PVD (Physical Vapor Deposition) or CVD (Chemical Vapor Deposition) deposition type.

1. A method for manufacturing particles, the method comprising:
depositing on a substrate a layer of a first sacrificial material;
depositing a layer of a second sacrificial material that is different from said first sacrificial material;
structuring the layer of the second sacrificial material by forming holes in the shape of the magnetic particles to be manufactured, said structuring of the layer of second sacrificial material being done by using a structured mold, by pressing said mold against said layer of second sacrificial material;
depositing at least one material for manufacturing said particles, said manufacturing material covering the layer of the second material and at least partially filling said holes;
selectively removing said second sacrificial material from said first sacrificial material so as to obtain the particles formed by said manufacturing material filling the holes and arranged on said layer of said first sacrificial material;
eliminating said first sacrificial material such that said particles are released.

2. The method according to claim 1, wherein said holes are arranged so as to form an array of holes distributed on said layer of a second sacrificial material.

3. The method according to claim 1, wherein said mold comprises protuberances, the third-dimensional form of which determines the form of said holes.

4. The method according to claim 1, wherein a glass transition temperature of said second sacrificial material is strictly less than a glass transition temperature of said first sacrificial material.

5. The method according to claim 1, wherein said selective removal is carried out by dissolving said second sacrificial material in an appropriate solvent, said solvent dissolving only said second sacrificial material without affecting said first sacrificial material, said part of the manufacturing material present in said holes remaining attached to said layer of first sacrificial material.

6. The method according to claim 1, wherein said elimination of said first sacrificial material is carried out by dissolving said first sacrificial material.

7. The method according to claim 1, wherein said first material is a methyl methacrylate type polymer.

8. The method according to claim 1, wherein said first material is a material chosen from among the following materials:
amorphous or semicrystalline polymer;
oligomer;
monomer;
metal;
oxide;
ceramic;
biological material.

9. The method according to claim 1, wherein said second material is a material chosen from among the following materials:
amorphous or semicrystalline polymer;
oligomer;
monomer;
metal;
oxide;
biological material.

10. The method according to claim 1, wherein said manufacturing material is a magnetic material so that magnetic particles are obtained.

11. The method according to claim 10, wherein depositing said at least one magnetic material comprises depositing a multilayer formed by a plurality of magnetic layers with antiparallel magnetization separated by a non-magnetic layer made in a material able to induce antiferromagnetic coupling between the magnetic layers that it separates.

12. The method according to claim 11, wherein said magnetic multilayer is an iron/chromium multilayer of general form (Fe/Cr)m or a nickel-iron-cobalt/ruthenium alloy multilayer of general form (Ni_{1-x-y}FeₓCo_{y}/Ru)n, x and y being real numbers between 0 and 1 characterizing the relative concentrations of Fe and Co in the alloy, m and n designating natural integers respectively corresponding to the numbers of respective repetitions of Fe/Cr and Ni_{1-x-y}FeₓCo_{y}/Ru patterns.

13. The method according to claim 10, wherein said at least one magnetic material is chosen so that it presents a substantially squared hysteresis loop.

14. The method according to claim 1, wherein depositing said at least one manufacturing material is preceded by depositing a first layer of biocompatible material and is followed by depositing a second layer of biocompatible material so that said biocompatible material is on both sides of said manufacturing material.

15. The method according to claim 14, comprising chemically treating the sides of said particles to deposit a biocompatible material on said sides.

16. The method according to claim 1, comprising grafting elements of interest onto said particles.

17. The method according to claim 7, wherein said first material is PMMA.

18. A method for manufacturing particles, the method comprising:
depositing on a substrate a layer of a first sacrificial material;
depositing on the layer of the first sacrificial material a layer of a second sacrificial material that is different from said first sacrificial material;
forming cavities in the layer of the second sacrificial material, said forming comprising pressing a structured mold against said layer of second sacrificial material;
depositing a material for manufacturing said particles, said material covering the layer of the second material and at least partially filling said cavities;
selectively removing said second sacrificial material from said first sacrificial material so as to obtain the particles formed by said material and arranged on said layer of said first sacrificial material; and
eliminating said first sacrificial material to release said particles.
